(19) United States
(12) Patent Application Publication
(10) Pub. No.: US 2020/0274232 A1
(43) Pub. Date: Aug. 27, 2020

(54) ELECTRONIC DEVICE, AND METHOD FOR CONTROLLING ANTENNA OF ELECTRONIC DEVICE

(71) Applicant: Samsung Electronics Co., Ltd., Gyeonggi-do (KR)

(72) Inventors: Wonsub LIM, Seoul (KR); Hyoseok NA, Gyeonggi-do (KR); Dongil YANG, Gyeonggi-do (KR)

(21) Appl. No.: 16/651,113

(22) PCT Filed: Oct. 1, 2018
(86) PCT No.: PCT/KR2018/011636

§ 371 Date: Mar. 26, 2020

(30) Foreign Application Priority Data
Sep. 29, 2017 (KR) 10-2017-0128285

(51) Int. Cl. H01Q 1/24; H04B 1/401; H04B 1/3827; H01Q 9/04

(52) U.S. Cl. CPC H01Q 1/245; H01Q 9/0442; H04B 1/3838; H04B 1/401

(57) ABSTRACT

An electronic device may comprise: a communication circuit; a sensor module; an antenna which can be electrically connected to the communication circuit via a path selected among a first path having a first loss value for the power value of a signal to be output through the communication circuit and a second path having a second loss value, greater than the first loss value, for the power value; and a processor, wherein the processor is configured to: output a signal at a designated power value by using the first antenna electrically connected to the communication circuit via the first path; check whether the electronic device is close to an external object, by using the sensor module; when the electronic device is close to the external object, change an electrical connection path between the communication circuit and the first antenna from the first path to the second path; and output a signal at the designated power value by using the first antenna electrically connected to the communication circuit via the second path.

### TECHNICAL FIELD

Various embodiments of the disclosure relate to an electronic device and a method for controlling an antenna of the electronic device.

### BACKGROUND ART

In various electronic devices capable of communication such as a smart phone, a tablet PC, a portable multimedia player (PMP), a personal digital assistant (PDA), a laptop personal computer (PC), and a wearable device including a wrist watch and a head-mounted display (HMD), recent research has shown that electromagnetic waves are harmful to a human body. Accordingly, there is a need for improvement of a specific absorption rate (SAR) at which energy is absorbed by the human body when exposed to the electromagnetic waves.

### DISCLOSURE OF INVENTION

### Technical Problem

The SAR increases in proportion to the intensity (power) of electromagnetic field generated from an antenna. Therefore, a typical solution for complying with an international standard for the SAR is to decrease radiation power. However, even if applying conduction power prescribed in the international standard, the SAR often exceeds the international standard.

Various embodiments of the disclosure relate to an electronic device and an antenna control method thereof, and are intended to lower the SAR by changing the antenna characteristics and thereby reducing the radiation power.

### Solution to Problem

According to embodiments of the disclosure, an electronic device may include a communication circuit; a sensor module; an antenna electrically connected to the communication circuit through a path selected from among a first path having a first loss value for a power value of a signal to be outputted through the communication circuit and a second path having a second loss value greater than the first loss value for the power value; and a processor. The processor may be configured to output a signal with a specific power value by using the first antenna electrically connected to the communication circuit through the first path, to check, using the sensor module, whether the electronic device is in proximity of an external object, to, when the electronic device is in proximity of the external object, change an electrical connection path between the communication circuit and the first antenna from the first path to the second path, and to output a signal with the specific power value by using the first antenna electrically connected to the communication circuit through the second path.

According to embodiments of the disclosure, an electronic device may include a communication circuit; a sensor module; an antenna electrically connected to the communication circuit through a path selected from among a first path having a first loss value for a power value of a signal to be outputted through the communication circuit and a second path having a second loss value greater than the first loss value for the power value; and a processor. The processor may be configured to check, using the sensor module, whether the electronic device is in proximity of an external object, to, when the electronic device and the external object are in a first specific range, output a signal with a specific power value by using the first antenna in a state where the first path is selected as an electrical connection path between the communication circuit and the first antenna, and to, when the electronic device and the external object are in a second specific range, output a signal with the specific power value by using the first antenna in a state where the second path is selected as an electrical connection path between the communication circuit and the first antenna.

According to embodiments of the disclosure, an electronic device may include a communication circuit; a sensor module; an antenna capable of transmitting and receiving a signal through a characteristic selected from among a first characteristic having a first loss value for a power value of a signal to be outputted through the communication circuit and a second characteristic having a second loss value greater than the first loss value for the power value; and a processor. The processor may be configured to check, using the sensor module, whether the electronic device is in proximity of an external object, and to, when the electronic device is in proximity of the external object, output a signal by using the antenna having the first characteristic and the second antenna having the second characteristic.

According to embodiments of the disclosure, an antenna control method of an electronic device may include operations of outputting a signal with a specific power value by using an antenna electrically connected to a communication circuit through a first path; checking, by using a sensor module, whether the electronic device is in proximity of an external object; when the electronic device is in proximity of the external object, changing an electrical connection path between the communication circuit and the antenna from the first path to a second path; and outputting a signal with the specific power value by using the antenna electrically connected to the communication circuit through the second path. The antenna may be electrically connected to the communication circuit through a path selected from among the first path having a first loss value for a power value of a signal to be outputted through the communication circuit and the second path having a second loss value greater than the first loss value for the power value.

### Advantageous Effects of Invention

The electronic device and the antenna control method thereof according to various embodiments of the disclosure may improve the total isotropic sensitivity (TIS) and the specific absorption rate (SAR) by changing antenna characteristics and thereby reducing radiation power.

### BRIEF DESCRIPTION OF DRAWINGS

FIG. 1 is a block diagram illustrating an electronic device in a network environment according to various embodiments.

FIG. 2 is a diagram illustrating a communication module according to various embodiments of the disclosure.

FIG. 3 is a flow diagram illustrating an antenna control operation according to various embodiments of the disclosure.

FIG. 4 is a flow diagram illustrating an antenna control operation according to various embodiments of the disclosure.

FIG. 5 is a flow diagram illustrating an antenna control operation according to various embodiments of the disclosure.

FIG. 6 is a flow diagram illustrating an antenna control operation according to various embodiments of the disclosure.

FIG. 7 is a diagram illustrating a frequency versus a voltage standing wave ratio by antenna control according to various embodiments of the disclosure.

FIG. 8 is a Smith chart illustrating an antenna gain adjustment method based on control of an antenna impedance tuner according to various embodiments of the disclosure.

FIG. 9 is a diagram illustrating an antenna module according to various embodiments of the disclosure.

### MODE FOR THE INVENTION

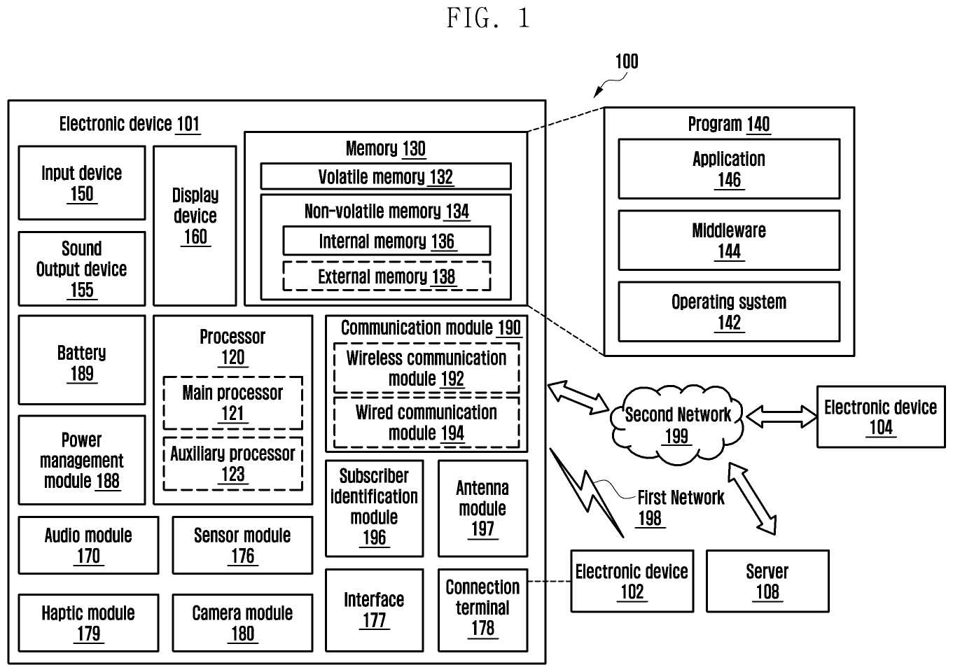

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). [symbol] According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module(SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main process or 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

[symbol] The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other.

According to an embodiment, the wireless communication module 192 may identify and authenticate the electronic device 101 in a communication network using subscriber information stored in the subscriber identification module 196.

The antenna module 197 may transmit or receive a signal or power to or from the outside of the electronic device 101. According to an embodiment, the communication module 190 (e.g., the wireless communication module 192) may transmit a signal to or receive a signal from an external electronic device through an antenna suitable for a communication method.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

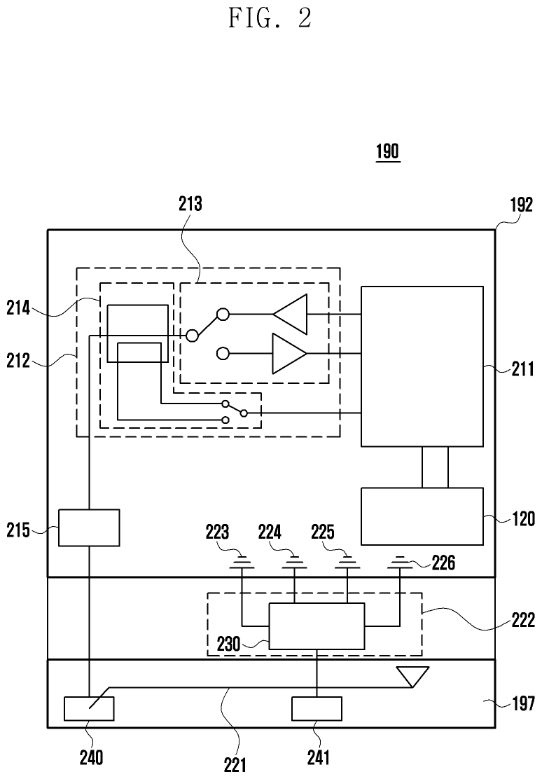

FIG. 2 is a diagram illustrating a communication module 190 according to various embodiments of the disclosure.

The communication module 190 (e.g., the communication module 190 in FIG. 1) may include a wireless communication module 192 (e.g., the wireless communication module 192 in FIG. 1) and an antenna module 197 (e.g., the antenna module 197 in FIG. 1).

The wireless communication module 192 may include a processor 120 (e.g., the processor 120 in FIG. 1), a transceiver 211, and a front end module 212.

The front end module 212 may include a switch unit 213 and a coupler unit 214. The coupler unit 214 may include a switch element.

In various embodiments, the wireless communication module 192 may exclude the processor 120 and the transceiver 211. In this case, the processor 120 may be replaced with a processor (e.g., the processor 120 in FIG. 1) included in the electronic device 101.

The processor 120 may transmit and receive a signal through the transceiver 211. The processor 120 or the transceiver 211 may control the front end module 212 to determine a transmission/reception direction.

The front end module 212 may transmit and receive a signal under the control of the processor 120 or the transceiver 211. The front end module 212 may deliver an outgoing signal to an antenna impedance tuner 215 during signal transmission, and deliver an incoming signal received through the antenna impedance tuner 215 to the transceiver 211 during signal reception.

The antenna impedance tuner 215 may deliver the outgoing signal to the antenna module 197, and deliver the incoming signal to the transceiver 211 or the processor 120.

The antenna module 197 may include an antenna 221, an antenna controller 222, and one or more power feeders 240 and 241. The antenna 221 may be connected to the one or more power feeders 240 and 241 to receive power.

The antenna controller 222 may receive power from the one or more power feeders 240 and 241 connected thereto.

The antenna controller 222 may control the characteristics of the antenna 221. For example, the antenna controller 222 may control at least one of a resonant frequency or a natural frequency of the antenna 221.

For example, the antenna controller 222 may control signal radiation or reception performance of the antenna 221.

The antenna controller 222 may control the characteristics of the antenna 221. The antenna module 197 may include one or more antenna paths 223, 224, 225, and 226.

The antenna controller 222 may control the one or more antenna paths 223, 224, 225, and 226 to control the characteristics of the antenna 221.

According to various embodiments, the processor 120 or the transceiver 211 may control the antenna controller 222 to select the one or more antenna paths 223, 224, 225, and 226.

The one or more antenna paths 223, 224, 225, and 226 are patterns or elements (e.g., inductance, resistance, and/or capacitance) and may have different resonant frequencies or natural frequencies.

Because the one or more antenna paths 223, 224, 225, and 226 have different resonant frequencies or natural frequencies as patterns or elements (e.g., inductance, resistance, and/or capacitance), it is possible to control the resonant frequency or natural frequency of the antenna by changing a path of the antenna 221.

For example, the first antenna path 223 may be the same as a first sub-antenna 223. The second antenna path 224 may be the same as a second sub-antenna 224. The third antenna path 225 may be the same as a third sub-antenna 225. The first antenna path 223 may be the same as the first sub-antenna 223.

The antenna controller 22 may control the resonant frequency or natural frequency of the antenna 221 by selectively connecting the antenna 221 with the one or more antenna paths 223, 224, 225, and 226.

The antenna controller 222 may control, under the control of the processor 120, the resonant frequency or natural frequency of the antenna 221 by selectively connecting the antenna 221 with the one or more antenna paths 223, 224, 225, and 226.

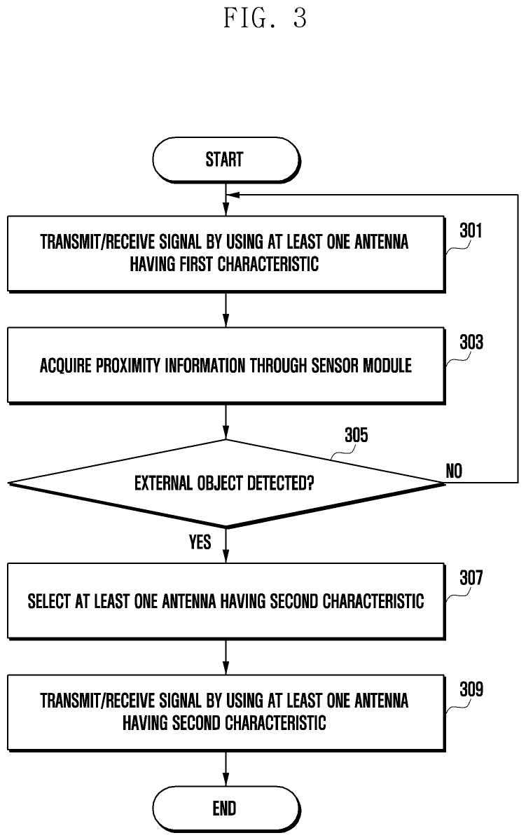

FIG. 3 is a flow diagram illustrating an antenna control operation according to various embodiments of the disclosure.

At operation 301, the electronic device 101 may transmit and receive a signal by using at least one antenna (e.g., the antenna 221 in FIG. 2) having a first characteristic under the control of the processor 120. The at least one antenna 221 having the first characteristic may be an antenna having a first resonant frequency or a first natural frequency by being selectively connected to the one or more antenna paths 223, 224, 225, and 226.

At operation 303, the electronic device 101 may acquire proximity information through a sensor module (e.g., the sensor module 176 in FIG. 1) under the control of the processor 120.

For example, using at least one of a grip sensor or a proximity sensor in the sensor module (e.g., the sensor module 176 in FIG. 1), the electronic device 101 may collect information (e.g., proximity information) about whether there is an external object that is in proximity of or in contact (e.g., by grip) with the electronic device 101.

At operation 305, the electronic device 101 may determine, based on the acquired proximity information under the control of the processor 120, whether an external object is detected.

In various embodiments, the above operation of determining whether an external object is detected may be an operation of determining whether the external object approaches the electronic device 101 within a predetermined distance.

In various embodiments, when it is determined based on the acquired proximity information that the external object approaches the electronic device 101 within the predetermined distance, the electronic device 101 may determine that the external object is detected.

In various embodiments, the above operation of determining whether an external object is detected may be an operation of determining whether the external object is in contact with the electronic device 101 or whether the electronic device 101 is gripped.

In various embodiments, when it is determined based on the acquired proximity information that the external object is in contact with the electronic device 101 or the electronic device 101 is gripped, the electronic device 101 may determine that the external object is detected.

When the external object is not detected based on the acquired proximity information under the control of the processor 120 at the operation 305, the electronic device 101 may return to the operation 301.

When the external object is detected based on the acquired proximity information under the control of the processor 120 at the operation 305, the electronic device 101 may perform operation 307.

At operation 307, under the control of the processor 120, the electronic device 101 may select at least one antenna having a second characteristic. The at least one antenna 221 having the second characteristic may be an antenna having a second resonant frequency or a second natural frequency by being selectively connected to the one or more antenna paths 223, 224, 225, and 226.

In various embodiments, at the operation 307, the electronic device 101 may control the at least one antenna 221 to be selectively connected to the one or more antennas paths 223, 224, 225, and 226 such that the at least one antenna 221 has the second characteristic.

According to various embodiments, at the operation 307, the electronic device 101 may control the at least one antenna to have the second characteristic under the control of the processor 120. When the external object is detected based on the acquired proximity information, the electronic device 101 may select the at least one antenna having the second characteristic under the control of the processor 120 at the operation 307.

According to various embodiments, when the external object is detected based on the acquired proximity information, the electronic device 101 may control the at least one antenna to have the second characteristic under the control of the processor 120 at the operation 307.

According to various embodiments, when the external object is detected based on the acquired proximity information, the electronic device 101 may control the antenna controller 222 to select the at least one antenna having the second characteristic under the control of the processor 120 at the operation 307.

According to various embodiments, when the external object is detected based on the acquired proximity information, the electronic device 101 may control the antenna controller 222 such that the at least one antenna has the second characteristic under the control of the processor 120 at the operation 307.

According to various embodiments, when the external object is detected based on the acquired proximity information, the electronic device 101 may control at least one of the antenna controller 222 and the antenna impedance tuner 215 to select the at least one antenna having the second characteristic under the control of the processor 120 at the operation 307.

According to various embodiments, when the external object is detected based on the acquired proximity information, the electronic device 101 may control at least one of the antenna controller 222 and the antenna impedance tuner 215 such that the at least one antenna has the second characteristic under the control of the processor 120 at the operation 307.

According to various embodiments, when the external object is detected based on the acquired proximity information, the electronic device 101 may control at least one of the antenna controller 222 and the antenna impedance tuner 215 to change an antenna path under the control of the processor 120 at the operation 307.

The at least one antenna having the first characteristic and the at least one antenna having the second characteristic may have different resonant frequencies or different natural frequencies.

For example, the resonant frequency or natural frequency of the at least one antenna having the second characteristic may be higher or lower than that of the at least one antenna having the first characteristic.

The at least one antenna having the first characteristic and the at least one antenna having the second characteristic may have different radiation efficiencies.

For example, the at least one antenna having the second characteristic may have a lower radiation efficiency than that of the at least one antenna having the first characteristic.

The at least one antenna having the first characteristic and the at least one antenna having the second characteristic may have different performances of transmitting and receiving a signal.

For example, the at least one antenna having the second characteristic may transmit and receive a smaller or greater signal than the at least one antenna having the first characteristic.

The at least one antenna having the first characteristic and the at least one antenna having the second characteristic may have different antenna gains.

For example, the at least one antenna having the first characteristic may have a greater antenna loss than that of the at least one antenna having the second characteristic.

At operation 309, the electronic device 101 may transmit and receive a signal by using the at least one antenna having the second characteristic under the control of the processor 120.

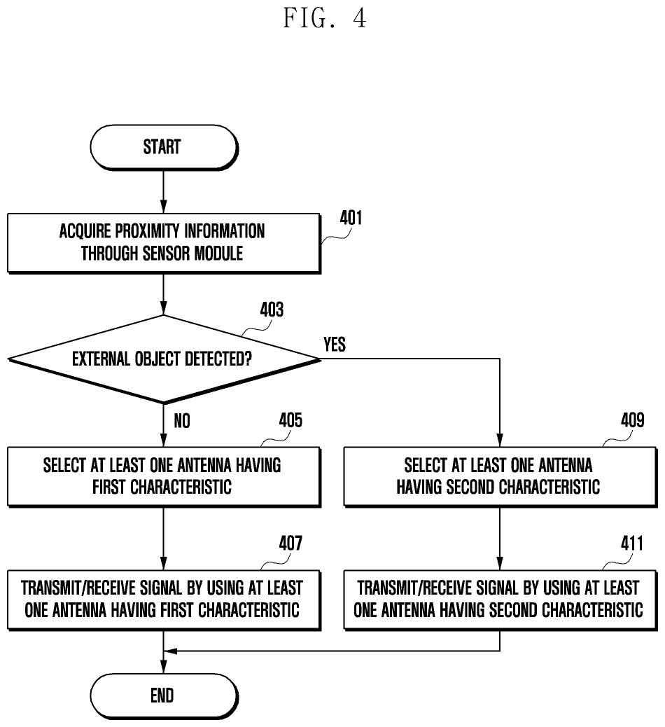

FIG. 4 is a flow diagram illustrating an antenna control operation according to various embodiments of the disclosure.

At operation 401, the electronic device 101 may acquire proximity information through a sensor module (e.g., the sensor module 176 in FIG. 1) under the control of the processor 120.

For example, using at least one of a grip sensor or a proximity sensor in the sensor module (e.g., the sensor module 176 in FIG. 1), the electronic device 101 may collect information (e.g., proximity information) about whether there is an external object that is in proximity of or in contact (e.g., by grip) with the electronic device 101.

At operation 403, the electronic device 101 may determine, based on the acquired proximity information under the control of the processor 120, whether an external object is detected.

In various embodiments, the above operation of determining whether an external object is detected may be an operation of determining whether the external object approaches the electronic device 101 within a predetermined distance.

In various embodiments, when it is determined based on the acquired proximity information that the external object approaches the electronic device 101 within the predetermined distance, the electronic device 101 may determine that the external object is detected.

In various embodiments, the above operation of determining whether an external object is detected may be an operation of determining whether the external object is in contact with the electronic device 101 or whether the electronic device 101 is gripped.

In various embodiments, when it is determined based on the acquired proximity information that the external object is in contact with the electronic device 101 or the electronic device 101 is gripped, the electronic device 101 may determine that the external object is detected.

In various embodiments, when the external object is not detected based on the acquired proximity information under the control of the processor 120 at the operation 403, the electronic device 101 may perform operation 405.

In various embodiments, when the external object is detected based on the acquired proximity information under the control of the processor 120 at the operation 403, the electronic device 101 may perform operation 409.

In various embodiments, at operation 405, the electronic device 101 may select at least one antenna (e.g., the antenna 221 in FIG. 2) having a first characteristic under the control of the processor 120.

In various embodiments, at the operation 405, the electronic device 101 may control the at least one antenna (e.g., the antenna 221 in FIG. 2) to have the first characteristic under the control of the processor 120.

In various embodiments, at the operation 405, the electronic device 101 may control the at least one antenna 221 to be selectively connected to the one or more antennas paths 223, 224, 225, and 226 such that the at least one antenna 221 has the first characteristic.

The at least one antenna 221 having the first characteristic may be an antenna having a first resonant frequency or a first natural frequency by being selectively connected to the one or more antenna paths 223, 224, 225, and 226.

In various embodiments, at the operation 405, the electronic device 101 may select the at least one antenna 221 having the first characteristic under the control of the processor 120.

In various embodiments, at the operation 405, the electronic device 101 may control the at least one antenna to have the first characteristic under the control of the processor 120.

In various embodiments, when the external object is not detected based on the acquired proximity information, the electronic device 101 may select the at least one antenna having the first characteristic under the control of the processor 120 at the operation 405.

In various embodiments, when the external object is not detected based on the acquired proximity information, the electronic device 101 may control the at least one antenna to have the first characteristic under the control of the processor 120 at the operation 405.

In various embodiments, when the external object is not detected based on the acquired proximity information, the electronic device 101 may control the antenna controller 222 to select the at least one antenna having the first characteristic under the control of the processor 120 at the operation 405.

In various embodiments, when the external object is not detected based on the acquired proximity information, the electronic device 101 may control the antenna controller 222 such that the at least one antenna has the first characteristic under the control of the processor 120 at the operation 405.

In various embodiments, when the external object is not detected based on the acquired proximity information, the electronic device 101 may control at least one of the antenna controller 222 and the antenna impedance tuner 215 to select the at least one antenna having the first characteristic under the control of the processor 120 at the operation 405.

In various embodiments, when the external object is not detected based on the acquired proximity information, the electronic device 101 may control at least one of the antenna controller 222 and the antenna impedance tuner 215 such that the at least one antenna has the first characteristic under the control of the processor 120 at the operation 405.

In various embodiments, when the external object is not detected based on the acquired proximity information, the electronic device 101 may control at least one of the antenna controller 222 and the antenna impedance tuner 215 to change an antenna path under the control of the processor 120 at the operation 405.

In various embodiments, at operation 407, the electronic device 101 may transmit and receive a signal by using the at least one antenna (e.g., the antenna 221 in FIG. 2) having the first characteristic under the control of the processor 120.

In various embodiments, at operation 409, the electronic device 101 may select at least one antenna having a second characteristic under the control of the processor 120.

In various embodiments, at the operation 409, the electronic device 101 may control the at least one antenna to have the second characteristic under the control of the processor 120.

In various embodiments, at the operation 409, the electronic device 101 may control the at least one antenna 221 to be selectively connected to the one or more antennas paths 223, 224, 225, and 226 such that the at least one antenna 221 has the second characteristic.

The at least one antenna 221 having the second characteristic may be an antenna having a second resonant frequency or a second natural frequency by being selectively connected to the one or more antenna paths 223, 224, 225, and 226.

In various embodiments, when the external object is detected based on the acquired proximity information, the electronic device 101 may select the at least one antenna having the second characteristic under the control of the processor 120 at the operation 409.

In various embodiments, when the external object is detected based on the acquired proximity information, the electronic device 101 may control the at least one antenna to have the second characteristic under the control of the processor 120 at the operation 409.

In various embodiments, when the external object is detected based on the acquired proximity information, the electronic device 101 may control the antenna controller 222 to select the at least one antenna having the second characteristic under the control of the processor 120 at the operation 409.

In various embodiments, when the external object is detected based on the acquired proximity information, the electronic device 101 may control the antenna controller 222 such that the at least one antenna has the second characteristic under the control of the processor 120 at the operation 409.

In various embodiments, when the external object is detected based on the acquired proximity information, the electronic device 101 may control at least one of the antenna controller 222 and the antenna impedance tuner 215 to select an antenna path and thereby select the at least one antenna having the second characteristic under the control of the processor 120 at the operation 409.

In various embodiments, when the external object is detected based on the acquired proximity information, the electronic device 101 may control at least one of the antenna controller 222 and the antenna impedance tuner 215 to change an antenna path under the control of the processor 120 at the operation 409.

The at least one antenna having the first characteristic and the at least one antenna having the second characteristic may have different resonant frequencies or different natural frequencies.

For example, the resonant frequency or natural frequency of the at least one antenna having the second characteristic may be higher or lower than that of the at least one antenna having the first characteristic.

The at least one antenna having the first characteristic and the at least one antenna having the second characteristic may have different radiation efficiencies.

For example, the at least one antenna having the second characteristic may have a lower radiation efficiency than that of the at least one antenna having the first characteristic.

The at least one antenna having the first characteristic and the at least one antenna having the second characteristic may have different performances of transmitting and receiving a signal.

For example, the at least one antenna having the second characteristic may transmit and receive a smaller or greater signal than the at least one antenna having the first characteristic.

The at least one antenna having the first characteristic and the at least one antenna having the second characteristic may have different antenna gains.

For example, the at least one antenna having the first characteristic may have a greater antenna loss than that of the at least one antenna having the second characteristic.

At operation 411, the electronic device 101 may transmit and receive a signal by using the at least one antenna having the second characteristic under the control of the processor 120.

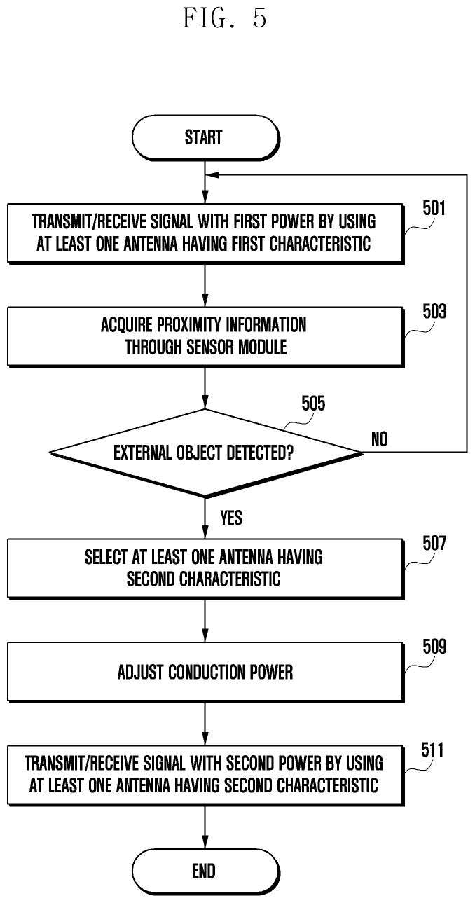

Table 1 shows total radiation power (TRP), total isotropic sensitivity (TIS), and SAR in case of changing an antenna path by controlling at least one of the antenna controller 222 and the antenna impedance tuner 215 without changing a predetermined conduction power, as in the antenna setup described above with reference to FIGS. 4 and 5.

TABLE 1

| | | | TRP | TIS | TRP, Total | TIS, Total | |
|---|---|---|---|---|---|---|---|
| Conduction | Antenna | | passive | passive | Radiation | Isotropic | |
| power | loss | Antenna | eff | eff | Power | Sensitivity | SAR |
| (dBm) | (dB) | path | (dBi) | (dBi) | (dBm) | (dBm) | (mW/g) |
| 23 | 1 | 1^{st} path | −4 | −5 | 18 | −94 | 4.2 |
| | | 223 | | | | | |
| | | 2^{nd} path | −5 | −4 | 17 | −95 | 3.9 |
| | | 224 | | | | | |
| | | 3^{rd} path | −6 | −5 | 16 | −94 | 3.6 |
| | | 225 | | | | | |
| | | 4^{th} path | −7 | −6 | 15 | −93 | 3.3 |
| | | 226 | | | | | |

As shown in Table 1, when the antenna path is changed to have a lower antenna gain or a higher resonant frequency, the TIS and the SAR can be improved with the conduction power unvaried.

FIG. 5 is a flow diagram illustrating an antenna control operation according to various embodiments of the disclosure.

In various embodiments, at operation 501, the electronic device 101 may transmit and receive a signal with a first power by using at least one antenna (e.g., the antenna 221 in FIG. 2) having a first characteristic under the control of the processor 120.

The at least one antenna 221 having the first characteristic may be an antenna having a first resonant frequency or a first natural frequency by being selectively connected to the one or more antenna paths 223, 224, 225, and 226.

In various embodiments, at operation 503, the electronic device 101 may acquire proximity information through a sensor module (e.g., the sensor module 176 in FIG. 1) under the control of the processor 120.

For example, using at least one of a grip sensor or a proximity sensor in the sensor module (e.g., the sensor module 176 in FIG. 1), the electronic device 101 may collect information (e.g., proximity information) about whether there is an external object that is in proximity of or in contact (e.g., by grip) with the electronic device 101.

In various embodiments, at operation 505, the electronic device 101 may determine, based on the acquired proximity information under the control of the processor 120, whether an external object is detected.

In various embodiments, the above operation of determining whether an external object is detected may be an operation of determining whether the external object approaches the electronic device 101 within a predetermined distance.

In various embodiments, when it is determined based on the acquired proximity information that the external object approaches the electronic device 101 within the predetermined distance, the electronic device 101 may determine that the external object is detected.

In various embodiments, the above operation of determining whether an external object is detected may be an operation of determining whether the external object is in contact with the electronic device 101 or whether the electronic device 101 is gripped.

In various embodiments, when it is determined based on the acquired proximity information that the external object is in contact with the electronic device 101 or the electronic device 101 is gripped, the electronic device 101 may determine that the external object is detected.

When the external object is not detected based on the acquired proximity information under the control of the processor 120 at the operation 505, the electronic device 101 may return to the operation 501.

When the external object is detected based on the acquired proximity information under the control of the processor 120 at the operation 505, the electronic device 101 may perform operation 507.

In various embodiments, at operation 507, the electronic device 101 may select an antenna having a second characteristic under the control of the processor 120.

In various embodiments, at the operation 507, the electronic device 101 may control the antenna to have the second characteristic under the control of the processor 120.

In various embodiments, when the external object is detected based on the acquired proximity information, the electronic device 101 may control the antenna controller 222 to select the at least one antenna having the second characteristic under the control of the processor 120 at the operation 507.

In various embodiments, when the external object is detected based on the acquired proximity information, the electronic device 101 may control the antenna controller 222 such that the at least one antenna has the second characteristic under the control of the processor 120 at the operation 507.

In various embodiments, at the operation 507, the electronic device 101 may control the at least one antenna 221 to be selectively connected to the one or more antennas paths 223, 224, 225, and 226 such that the at least one antenna 221 has the second characteristic.

The at least one antenna 221 having the second characteristic may be an antenna having a second resonant frequency or a second natural frequency by being selectively connected to the one or more antenna paths 223, 224, 225, and 226.

In various embodiments, when the external object is detected based on the acquired proximity information, the electronic device 101 may control at least one of the antenna controller 222 and the antenna impedance tuner 215 to select the at least one antenna having the second characteristic under the control of the processor 120 at the operation 507.

In various embodiments, when the external object is detected based on the acquired proximity information, the electronic device 101 may control at least one of the antenna controller 222 and the antenna impedance tuner 215 such that the at least one antenna has the second characteristic under the control of the processor 120 at the operation 507.

In various embodiments, when the external object is detected based on the acquired proximity information, the electronic device 101 may control at least one of the antenna controller 222 and the antenna impedance tuner 215 to change an antenna path under the control of the processor 120 at the operation 507.

The at least one antenna having the first characteristic and the at least one antenna having the second characteristic may have different resonant frequencies or different natural frequencies.

For example, the resonant frequency or natural frequency of the at least one antenna having the second characteristic may be higher or lower than that of the at least one antenna having the first characteristic.

The at least one antenna having the first characteristic and the at least one antenna having the second characteristic may have different radiation efficiencies.

For example, the at least one antenna having the second characteristic may have a lower radiation efficiency than that of the at least one antenna having the first characteristic.

The at least one antenna having the first characteristic and the at least one antenna having the second characteristic may have different performances of transmitting and receiving a signal.

For example, the at least one antenna having the second characteristic may transmit and receive a smaller or greater signal than the at least one antenna having the first characteristic.

The at least one antenna having the first characteristic and the at least one antenna having the second characteristic may have different antenna gains.

For example, the at least one antenna having the first characteristic may have a greater antenna loss than that of the at least one antenna having the second characteristic.

In various embodiments, at operation 509, the electronic device 101 may adjust conduction power under the control of the processor 120. This operation of adjusting the conduction power may be an operation of lowering the conduction power to a specific power.

In various embodiments, at the operation 509, the electronic device 101 may adjust the conduction power from a first power to a second power under the control of the processor 120.

In various embodiments, at the operation 509, the electronic device 101 may adjust the conduction power from the first power to the second power, based on a predetermined power, under the control of the processor 120.

The second power may be equal to or lower than the first power.

In various embodiments, the operation 509 of adjusting the conduction power based on the predetermined power may be an operation of lowering the power when the first power is higher than the predetermined power, and not adjusting the power when the first power is equal to the predetermined power.

For example, the predetermined power may be any power between 21 dBm and 23 dBm. If the predetermined power is 21 dBm and the first power is 21 dBm, the conduction power is not adjusted. In this case, the first power and the second power may be equal to each other. If the predetermined power is 21 dBm and the first power is 23 dBm, the conduction power may be adjusted to lower 2 dBm. In this case, the second power is lower than the first power.

In various embodiments, at operation 511, the electronic device 101 may transmit and receive a signal with the second power by using the at least one antenna having the second characteristic under the control of the processor 120.

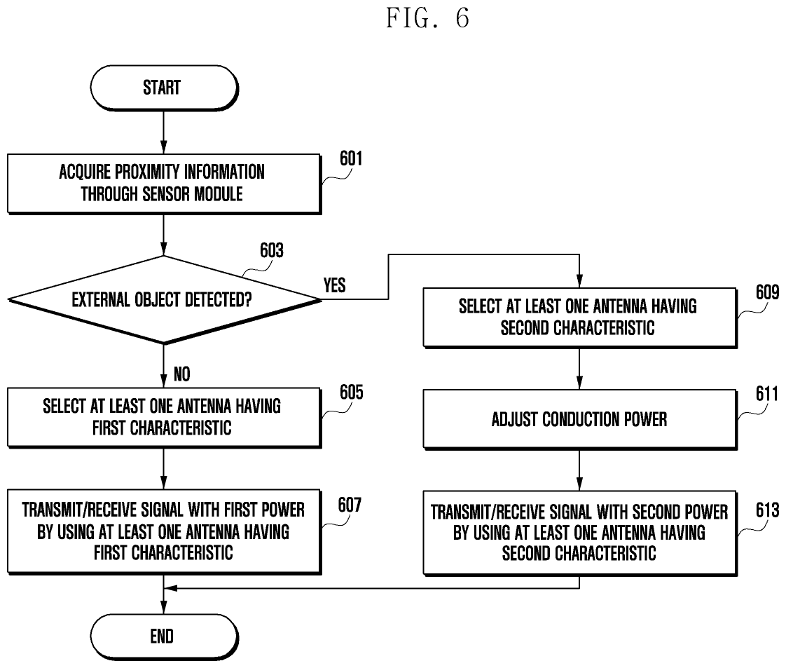

FIG. 6 is a flow diagram illustrating an antenna control operation according to various embodiments of the disclosure.

At operation 601, the electronic device 101 may acquire proximity information through a sensor module (e.g., the sensor module 176 in FIG. 1) under the control of the processor 120.

For example, using at least one of a grip sensor or a proximity sensor in the sensor module (e.g., the sensor module 176 in FIG. 1), the electronic device 101 may collect information (e.g., proximity information) about whether there is an external object that is in proximity of or in contact (e.g., by grip) with the electronic device 101.

At operation 603, the electronic device 101 may determine, based on the acquired proximity information under the control of the processor 120, whether an external object is detected.

In various embodiments, the above operation of determining whether an external object is detected may be an operation of determining whether the external object approaches the electronic device 101 within a predetermined distance.

In various embodiments, when it is determined based on the acquired proximity information that the external object approaches the electronic device 101 within the predetermined distance, the electronic device 101 may determine that the external object is detected.

In various embodiments, the above operation of determining whether an external object is detected may be an operation of determining whether the external object is in contact with the electronic device 101 or whether the electronic device 101 is gripped.

In various embodiments, when it is determined based on the acquired proximity information that the external object is in contact with the electronic device 101 or the electronic device 101 is gripped, the electronic device 101 may determine that the external object is detected.

In various embodiments, when the external object is not detected based on the acquired proximity information under the control of the processor 120 at the operation 603, the electronic device 101 may perform operation 605.

In various embodiments, when the external object is detected based on the acquired proximity information under the control of the processor 120 at the operation 603, the electronic device 101 may perform operation 609.

In various embodiments, at operation 605, the electronic device 101 may select at least one antenna (e.g., the antenna 221 in FIG. 2) having a first characteristic under the control of the processor 120.

In various embodiments, at the operation 605, the electronic device 101 may control the at least one antenna (e.g., the antenna 221 in FIG. 2) to have the first characteristic under the control of the processor 120.

In various embodiments, at the operation 605, the electronic device 101 may control the at least one antenna 221 to be selectively connected to the one or more antennas paths 223, 224, 225, and 226 such that the at least one antenna 221 has the first characteristic.

The at least one antenna 221 having the first characteristic may be an antenna having a first resonant frequency or a first natural frequency by being selectively connected to the one or more antenna paths 223, 224, 225, and 226.

In various embodiments, when the external object is not detected based on the acquired proximity information, the electronic device 101 may select the at least one antenna having the first characteristic under the control of the processor 120 at the operation 605.

In various embodiments, when the external object is not detected based on the acquired proximity information, the electronic device 101 may control the at least one antenna to have the first characteristic under the control of the processor 120 at the operation 605.

In various embodiments, when the external object is not detected based on the acquired proximity information, the electronic device 101 may control the antenna controller 222 to select the at least one antenna having the first characteristic under the control of the processor 120 at the operation 605.

In various embodiments, when the external object is not detected based on the acquired proximity information, the electronic device 101 may control the antenna controller 222 such that the at least one antenna has the first characteristic under the control of the processor 120 at the operation 605.

In various embodiments, when the external object is not detected based on the acquired proximity information, the electronic device 101 may control at least one of the antenna controller 222 and the antenna impedance tuner 215 to select the at least one antenna having the first characteristic under the control of the processor 120 at the operation 605.

In various embodiments, when the external object is not detected based on the acquired proximity information, the electronic device 101 may control at least one of the antenna controller 222 and the antenna impedance tuner 215 such that the at least one antenna has the first characteristic under the control of the processor 120 at the operation 605.

In various embodiments, when the external object is not detected based on the acquired proximity information, the electronic device 101 may control at least one of the antenna controller 222 and the antenna impedance tuner 215 to change an antenna path under the control of the processor 120 at the operation 605.

In various embodiments, at operation 607, the electronic device 101 may transmit and receive a signal with a first power by using the at least one antenna (e.g., the antenna 221 in FIG. 2) having the first characteristic under the control of the processor 120.

In various embodiments, at operation 609, the electronic device 101 may select at least one antenna having a second characteristic under the control of the processor 120.

In various embodiments, at the operation 609, the electronic device 101 may control the at least one antenna to have the second characteristic under the control of the processor 120.

The at least one antenna 221 having the second characteristic may be an antenna having a second resonant frequency or a second natural frequency by being selectively connected to the one or more antenna paths 223, 224, 225, and 226.

In various embodiments, at the operation 609, the electronic device 101 may control the at least one antenna 221 to be selectively connected to the one or more antennas paths 223, 224, 225, and 226 such that the at least one antenna 221 has the second characteristic.

In various embodiments, when the external object is detected based on the acquired proximity information, the electronic device 101 may select the at least one antenna having the second characteristic under the control of the processor 120 at the operation 609.

In various embodiments, when the external object is detected based on the acquired proximity information, the electronic device 101 may control the at least one antenna to have the second characteristic under the control of the processor 120 at the operation 609.

In various embodiments, when the external object is detected based on the acquired proximity information, the electronic device 101 may control the antenna controller 222 to select the at least one antenna having the second characteristic under the control of the processor 120 at the operation 609.

In various embodiments, when the external object is detected based on the acquired proximity information, the electronic device 101 may control the antenna controller 222 such that the at least one antenna has the second characteristic under the control of the processor 120 at the operation 609.

In various embodiments, when the external object is detected based on the acquired proximity information, the electronic device 101 may control at least one of the antenna controller 222 and the antenna impedance tuner 215 to select an antenna path and thereby select the at least one antenna having the second characteristic under the control of the processor 120 at the operation 609.

In various embodiments, when the external object is detected based on the acquired proximity information, the electronic device 101 may control at least one of the antenna controller 222 and the antenna impedance tuner 215 to select an antenna path and thereby allow the at least one antenna to have the second characteristic under the control of the processor 120 at the operation 609.

In various embodiments, when the external object is detected based on the acquired proximity information, the electronic device 101 may control at least one of the antenna controller 222 and the antenna impedance tuner 215 to change an antenna path under the control of the processor 120 at the operation 609.

The at least one antenna having the first characteristic and the at least one antenna having the second characteristic may have different resonant frequencies or different natural frequencies.

For example, the resonant frequency or natural frequency of the at least one antenna having the second characteristic may be higher or lower than that of the at least one antenna having the first characteristic.

The at least one antenna having the first characteristic and the at least one antenna having the second characteristic may have different radiation efficiencies.

For example, the at least one antenna having the second characteristic may have a lower radiation efficiency than that of the at least one antenna having the first characteristic.

The at least one antenna having the first characteristic and the at least one antenna having the second characteristic may have different performances of transmitting and receiving a signal.

For example, the at least one antenna having the second characteristic may transmit and receive a smaller or greater signal than the at least one antenna having the first characteristic.

The at least one antenna having the first characteristic and the at least one antenna having the second characteristic may have different antenna gains.

For example, the at least one antenna having the first characteristic may have a greater antenna loss than that of the at least one antenna having the second characteristic.

In various embodiments, at operation 611, the electronic device 101 may adjust conduction power under the control of the processor 120. This operation of adjusting the conduction power may be an operation of lowering the conduction power to a specific power.

In various embodiments, at the operation 611, the electronic device 101 may adjust the conduction power from a first power to a second power under the control of the processor 120.

In various embodiments, at the operation 611, the electronic device 101 may adjust the conduction power from the first power to the second power, based on a predetermined power, under the control of the processor 120.

In various embodiments, the operation 611 of adjusting the conduction power based on the predetermined power may be an operation of lowering the power when the first power is higher than the predetermined power, and not adjusting the power when the first power is equal to the predetermined power.

The second power may be equal to or lower than the first power.

For example, the predetermined power may be any power between 21 dBm and 23 dBm. If the predetermined power is 21 dBm and the first power is 21 dBm, the conduction power is not adjusted. In this case, the first power and the second power may be equal to each other. If the predetermined power is 21 dBm and the first power is 23 dBm, the conduction power may be adjusted to lower 2 dBm. In this case, the second power is lower than the first power.

In various embodiments, at operation 613, the electronic device 101 may transmit and receive a signal with the second power by using the at least one antenna having the second characteristic under the control of the processor 120.

Table 2 shows total radiation power (TRP), total isotropic sensitivity (TIS), and SAR in case of changing an antenna path by controlling at least one of the antenna controller 222 and the antenna impedance tuner 215 while changing a conduction power, as in the antenna setup described above with reference to FIGS. 5 and 6.

TABLE 2

| | | | 1920 MHz | 2110 MHz | TRP, Total | TIS, Total | |
|---|---|---|---|---|---|---|---|
| Conduction | Antenna | | TRP passive | TIS passive | Radiation | Isotropic | |
| power | loss | Antenna | eff | eff | Power | Sensitivity | SAR |
| (dBm) | (dB) | path | (dBi) | (dBi) | (dBm) | (dBm) | (mW/g) |
| 23 | 1 | 1^{st} path | −4 | −5 | 18 | −94 | 5 |
| | | 223 | | | | | |
| | | 2^{nd} path | −5 | −4 | 17 | −95 | 4.6 |
| | | 224 | | | | | |
| | | 3^{rd} path | −6 | −5 | 16 | −94 | 4.2 |
| | | 225 | | | | | |
| | | 4^{th} path | −7 | −6 | 15 | −93 | 3.9 |
| | | 226 | | | | | |
| 22 | 1 | 1^{st} path | −4 | −5 | 17 | −94 | 4.6 |
| | | 223 | | | | | |
| | | 2^{nd} path | −5 | −4 | 16 | −95 | 4.2 |
| | | 224 | | | | | |
| | | 3^{rd} path | −6 | −5 | 15 | −94 | 3.9 |
| | | 225 | | | | | |
| | | 4^{th} path | −7 | −6 | 14 | −93 | 3.6 |
| | | 226 | | | | | |
| 21 | 1 | 1^{st} path | −4 | −5 | 16 | −94 | 4.2 |
| | | 223 | | | | | |
| | | 2^{nd} path | −5 | −4 | 15 | −95 | 3.9 |
| | | 224 | | | | | |
| | | 3^{rd} path | −6 | −5 | 14 | −94 | 3.6 |
| | | 225 | | | | | |
| | | 4^{th} path | −7 | −6 | 13 | −93 | 3.3 |
| | | 226 | | | | | |

As shown in Table 2, when the antenna path is changed to have a lower antenna gain or a higher resonant frequency, the TIS and the SAR can be improved with the conduction power unvaried.

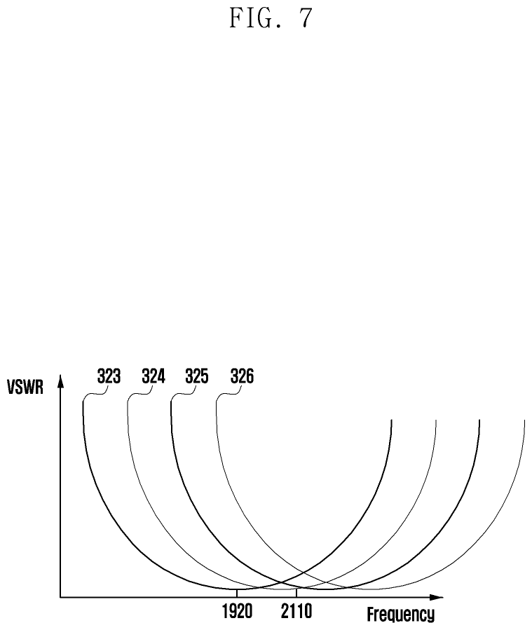

FIG. 7 is a diagram illustrating a frequency versus a voltage standing wave ratio by antenna control according to various embodiments of the disclosure.

The first antenna path 223 to the fourth antenna path 226 may be at least one antenna having the first or second characteristics of FIGS. 2 to 6.

The memory 130 of the electronic device 101 may store antenna paths for each state as a look up table.

The processor 120 of the electronic device 101 may control the antenna characteristics by controlling the antenna controller 222, based on the antenna paths stored in the memory.

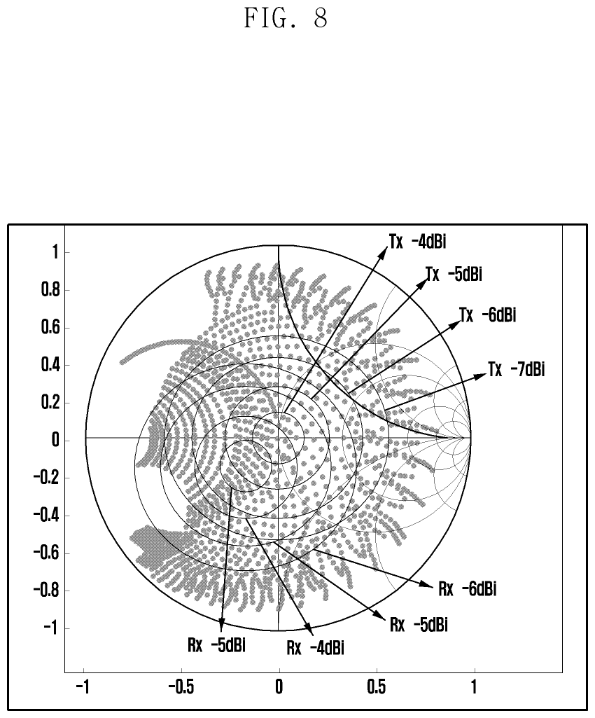

FIG. 8 is a Smith chart illustrating an antenna gain adjustment method based on control of an antenna impedance tuner 215 according to various embodiments of the disclosure.

The memory 130 of the electronic device 101 may store antenna gains for each state as a look up table.

The processor 120 of the electronic device 101 may control the antenna characteristics by controlling the impedance tuner 215, based on the antenna gains stored in the memory.

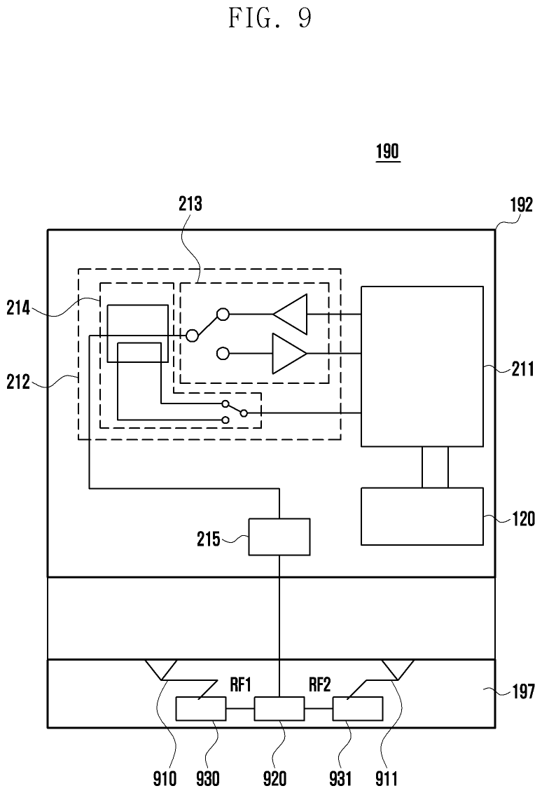

FIG. 9 is a diagram illustrating a communication module 190 according to various embodiments of the disclosure.

The communication module 190 (e.g., the communication module 190 in FIG. 1) may include a wireless communication module 192 (e.g., the wireless communication module 192 in FIG. 1) and an antenna module 197 (e.g., the antenna module 197 in FIG. 1).

The wireless communication module 192 may include a processor 120 (e.g., the processor 120 in FIG. 1), a transceiver 211, and a front end module 212.

The front end module 212 may include a switch unit 213 and a coupler unit 214. The coupler unit 214 may include a switch element.

In various embodiments, the wireless communication module 192 may exclude the processor 120 and the transceiver 211. In this case, the processor 120 may be replaced with a processor (e.g., the processor 120 in FIG. 1) included in the electronic device 101.

The processor 120 may transmit and receive a signal through the transceiver 211. The processor 120 or the transceiver 211 may control the front end module 212 to determine a transmission/reception direction.

The front end module 212 may transmit and receive a signal under the control of the processor 120 or the transceiver 211. The front end module 212 may deliver an outgoing signal to an antenna impedance tuner 215 during signal transmission, and deliver an incoming signal received through the antenna impedance tuner 215 to the transceiver 211 during signal reception.

The antenna impedance tuner 215 may deliver the outgoing signal to the antenna module 197, and deliver the incoming signal to the transceiver 211 or the processor 120.

The antenna module 197 may include two or more antennas 910 and 911, an antenna controller 920, and one or more power feeders 930 and 931. Each of the two or more antennas 910 and 911 may be connected to the one or more power feeders 930 and 931 to receive power.

The antenna controller 920 may receive power from two or more power feeders 930 and 931 connected thereto.

The antenna controller 920 may control the characteristics of the two or more antennas 910 and 911. For example, the antenna controller 920 may control at least one of a resonant frequency or a natural frequency of each of the two or more antennas 910 and 911.

For example, the antenna controller 920 may control signal radiation or reception performance of the two or more antennas 910 and 911.

The antenna controller 920 may control the characteristics of the two or more antennas 910 and 911. The antenna module may include one or more antenna paths (not shown).

The antenna controller 920 may control the one or more antenna paths (not shown) to control the characteristics of the two or more antennas 910 and 911.

According to various embodiments, the processor 120 or the transceiver 211 may control the characteristics of the two or more antennas 910 and 911 by controlling the antenna controller 920 to select the one or more antenna paths (not shown).

The one or more antenna paths (not shown) are composed of antennas having different resonant frequencies or natural frequencies.

Because of transmitting/receiving a signal by using the two or more antennas 910 and 911, the electronic device 101 may disperse an energy radiation path and lower an SAR value.

Table 3 shows total radiation power (TRP), total isotropic sensitivity (TIS), and SAR in case of a single energy radiation path and in case of two or more energy radiation paths shown in FIG. 9.

TABLE 3

| | | | TRP | TIS | TRP, Total | TIS, Total | |
|---|---|---|---|---|---|---|---|
| Conduction | Antenna | | passive | passive | Radiation | Isotropic | |
| power | loss | Antenna | eff | eff | Power | Sensitivity | SAR |
| (dBm) | (dB) | path | (dBi) | (dBi) | (dBm) | (dBm) | (mW/g) |
| 23 | 1 | 1^{st} antenna | −4 | −5 | 18 | −94 | 5 |
| | | in case | | | | | |
| | | of one | | | | | |
| | | radiation | | | | | |
| | | path | | | | | |
| | | 2^{nd} antenna | −4 | −5 | 18 | −94 | 5 |
| | | in case | | | | | |
| | | of one | | | | | |
| | | radiation | | | | | |
| | | path | | | | | |
| | | antenna | −4 | −5 | 18 | −94 | 3.9 |
| | | in case | | | | | |
| | | of two | | | | | |
| | | or more | | | | | |
| | | radiation | | | | | |
| | | paths | | | | | |
| 20 | 1 | 1^{st} antenna | −4 | −5 | 15 | −94 | 3.9 |
| | | in case | | | | | |
| | | of one | | | | | |
| | | radiation | | | | | |
| | | path | | | | | |

As shown in Table 3, when the antenna radiation paths are two or more, the TIS and the SAR can be improved with the conduction power unvaried.

The electronic device according to various embodiments of the disclosure may be of various types. For example, the electronic device may include at least one of a portable communication device (e.g., a smart phone), a computer device, a portable multimedia device, a portable medical device, a camera, a wearable device, or a home appliance. The electronic device according to embodiments of the disclosure is not limited to the above-described devices.

The embodiments and terms used herein are not intended to limit the technology disclosed in specific forms and should be understood to include various modifications, equivalents, and/or alternatives to corresponding embodiments. In the drawings, similar reference numbers are used to indicate similar constituent elements. As used herein, singular forms are intended to include plural forms as well, unless the context clearly indicates otherwise. In the disclosure, the expression “A or B”, “at least one of A and/or B”, “A, B, or C”, or “at least one of A, B, and/or C” is intended to include any possible combination of enumerated items. In the disclosure, expressions such as “1st” or “first”, “2nd” or “second”, etc. may modify various components regardless of the order and/or the importance but do not limit corresponding components. When it is mentioned that a certain (first) component is “(functionally or communicatively) connected” to or “accessed” by another (second) component, it may be understood that the component is directly connected to or accessed by the other component or that still other (third) component is interposed between the two components.

As used herein, the term “module” may include a unit implemented in hardware, software, or firmware, and may interchangeably be used with other terms, for example, logic, logical block, component, or circuit. A module may be a single integral component, or a minimum unit or part thereof, adapted to perform one or more functions. For example, according to an embodiment, the module may be implemented in a form of an application-specific integrated circuit (ASIC).

Various embodiments of the disclosure may be implemented as software (e.g., the program 140) including instructions that are stored in a machine-readable storage medium (e.g., the internal memory 136 or the external memory 138) that is readable by a machine (e.g., a computer). The machine is a device capable of invoking the instructions stored in the storage medium and operating in accordance with the invoked instructions, and may include the electronic device (e.g., the electronic device 101) according to the disclosed embodiments. When the instructions are executed by a processor (e.g., the processor 120), the processor may perform a function corresponding to the instructions directly or by using other components under the control of the processor. The instructions may include a code generated by a complier or a code executable by an interpreter. The machine-readable storage medium may be provided in the form of a non-transitory storage medium. The term “non-transitory” simply means that the storage medium is a tangible device and does not include a signal, but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a communication circuit;
a sensor module;
an antenna electrically connected to the communication circuit through a path selected from among a first path having a first loss value for a power value of a signal to be outputted through the communication circuit and a second path having a second loss value greater than the first loss value for the power value; and
a processor,
wherein the processor is configured to:
output a signal with a specific power value by using the first antenna electrically connected to the communication circuit through the first path,
check, using the sensor module, whether the electronic device is in proximity of an external object,
when the electronic device is in proximity of the external object, change an electrical connection path between the communication circuit and the first antenna from the first path to the second path, and
output a signal with the specific power value by using the first antenna electrically connected to the communication circuit through the second path.

2. The electronic device of claim 1, wherein the sensor module includes at least one of a proximity sensor and a grip sensor.

3. The electronic device of claim 1, wherein when determining, using the sensor module, that the electronic device and the external object are within a predetermined distance, the processor determines that the electronic device is in proximity of the external object.

4. The electronic device of claim 1, wherein the processor is further configured to:
determine whether a conduction power is greater than or equal to a predetermined power, and
lower the specific power value when the electronic device is in proximity of the external object and when the conduction power is greater than or equal to the predetermined power.

5. The electronic device of claim 4, wherein the processor is further configured to:
output the signal with the specific power value when the electronic device is in proximity of the external object and when the conduction power is equal to the predetermined power.

6. The electronic device of claim 1, wherein the antenna has at least two dispersed paths.

7. An electronic device comprising:
a communication circuit;
a sensor module;
an antenna electrically connected to the communication circuit through a path selected from among a first path having a first loss value for a power value of a signal to be outputted through the communication circuit and a second path having a second loss value greater than the first loss value for the power value; and
a processor,
wherein the processor is configured to:
check, using the sensor module, whether the electronic device is in proximity of an external object,
when the electronic device and the external object are in a first specific range, output a signal with a specific power value by using the first antenna in a state where the first path is selected as an electrical connection path between the communication circuit and the first antenna, and
when the electronic device and the external object are in a second specific range, output a signal with the specific power value by using the first antenna in a state where the second path is selected as an electrical connection path between the communication circuit and the first antenna.

8. The electronic device of claim 7, wherein the sensor module includes at least one of a proximity sensor and a grip sensor.

9. The electronic device of claim 7, wherein when determining, using the sensor module, that the electronic device and the external object are in the first specific range, the processor determines that the electronic device is in proximity of the external object, and
wherein when determining, using the sensor module, that the electronic device and the external object are in the second specific range, the processor determines that the electronic device is not in proximity of the external object.

10. The electronic device of claim 7, wherein the processor is further configured to:
determine whether a conduction power is greater than or equal to a predetermined power, and
lower the specific power value when the electronic device is in proximity of the external object and when the conduction power is greater than or equal to the predetermined power.

11. The electronic device of claim 10, wherein the processor is further configured to:
output the signal with the specific power value when the electronic device is in proximity of the external object and when the conduction power is equal to the predetermined power.

12. The electronic device of claim 7, wherein the antenna has at least two dispersed paths.

13. An electronic device comprising:
a communication circuit;
a sensor module;
an antenna capable of transmitting and receiving a signal through a characteristic selected from among a first characteristic having a first loss value for a power value of a signal to be outputted through the communication circuit and a second characteristic having a second loss value greater than the first loss value for the power value; and
a processor,
wherein the processor is configured to:
check, using the sensor module, whether the electronic device is in proximity of an external object, and
when the electronic device is in proximity of the external object, output a signal by using the antenna having the first characteristic and the second antenna having the second characteristic.

14. The electronic device of claim 13, wherein the sensor module includes at least one of a proximity sensor and a grip sensor.

15. The electronic device of claim 13, wherein when determining, using the sensor module, that the electronic device and the external object are within a predetermined distance, the processor determines that the electronic device is in proximity of the external object.
